(19) United States
(12) Patent Application Publication
(10) Pub. No.: US 2014/0095284 A1
(43) Pub. Date: Apr. 3, 2014

(54) USING UPGRADE OPTIONS TO PROVIDE PRICE DIFFERENTIATION FOR TRAVEL PRODUCTS

(71) Applicant: GetGoing, Inc., San Francisco, CA (US)

(72) Inventors: Alek Strygin, Foster City, CA (US); Alek Vernitsky, San Francisco, CA (US); Ilya Gluhovsky, Daly City, CA (US)

(73) Assignee: GetGoing, Inc., San Francisco, CA (US)

(21) Appl. No.: 14/092,442

(22) Filed: Nov. 27, 2013

Related U.S. Application Data
(63) Continuation of application No. 14/021,598, filed on Sep. 9, 2013.
(60) Provisional application No. 61/708,777, filed on Oct. 2, 2012.

(51) Int. Cl. G06Q 30/02

(52) U.S. Cl. CPC G06Q 30/0222
USPC 705/14.23

(57) ABSTRACT

The disclosed embodiments provide a system that facilitates a purchase of a travel product. Upon receiving a commitment to purchase the travel product from a first supplier by a buyer, the system presents the buyer with a first upgrade option of a first premium travel product from a second supplier. If the buyer accepts the first upgrade option, the system processes the purchase with the first premium travel product. If the buyer declines the first upgrade option, the system processes the purchase with the travel product.

### RELATED APPLICATION

The present patent is a continuation of, and hereby claims priority under 35 U.S.C. §120 to, pending U.S. patent application Ser. No. 14/021,598, entitled “Using Upgrade Options to Provide Price Differentiation for Travel Products,” by inventors Alek Strygin, Alek Vernitsky and Ilya Gluhovsky, filed on 9 Sep. 2013 (Attorney Docket No. GG12-1003), which claims the benefit of U.S. Provisional Application No. 61/708,777, Attorney Docket Number GG12-1003PSP, filed 2 Oct. 2012, both of which are hereby incorporated by reference.

### BACKGROUND

1. Field

The disclosed embodiments relate to market segmentation and price differentiation. More specifically, the disclosed embodiments relate to techniques for using upgrade options to provide price differentiation of travel products.

2. Related Art

Differential pricing, which includes product differentiation and price discrimination, is a pricing strategy commonly used by businesses for selling products like airline seats, hotel rooms, and/or other travel products. Differential pricing is used to sell the right number of products to targeted customers for an appropriate price in order to maximize profit from a fixed, perishable resource. Price discrimination or price differentiation refers to the practice of charging different prices for the same (or very similar) products that have the same costs of production, based solely on different consumers' willingness to pay (WTP). Product discrimination, on the other hand, involves charging different prices for products with different quality of service characteristics and, in general, different costs of production. Revenue systems utilize both price discrimination and product differentiation in an attempt to maximize yield. They offer a variety of products, involving differences in the quality of services, as well as differences in the purchase according to conditions and restrictions.

A related strategy is market segmentation, which refers to classifying individuals or identifying different demand groups or segments. Market segmentation techniques are used in order to maximize revenues from sale of a fixed, perishable commodity, such as a seat on an airline, a hotel room, cruises, car rental, or any other such products. In theory, total revenue from a product is maximized when each consumer pays a different price equal to his or her WTP. In practice, such a theoretical segmentation cannot be achieved as the system cannot determine each individual WTP for each particular product, nor can it publish different prices available only to specific individuals.

FIG. 1A illustrates a price demand curve used for price differentiation in airlines. The entire area under the sloping line represents the maximum revenue that an airline may derive from a given flight. If the airline offers an unrestricted fare P1 (price) to those consumers with a higher WTP, the airline can expect Q1 (quantity) consumers to purchase the fare because they have WTP equal to P1 or greater. However, the airline may leave a lot of revenue on the table, both because it did not charge a higher price for those consumers who have WTP>P1, and also because a number of seats are flying empty, as many consumers with WTP<P1 did not buy a ticket.

FIG. 1B illustrates a graphical representation of a typical differential pricing technique of a product. If the airline offers a lower or discount fare P2 to those consumers with a lower WTP, then Q2-Q1 additional consumers would be expected to purchase the lower fare, as they have WTP greater than P2 but less than P1. By introducing two fares, the airline is able to capture a greater portion of the total available revenue. This model assumes that consumers with a high WTP purchase the higher fare P1. Price discrimination presents a challenge of identifying and segmenting customers based on the strength of their preference for a specific product. Without it, profit/yield and market reach of a product are reduced.

For example, consumers prefer high-quality goods over low-quality goods, if prices for all goods are the same. By introducing products of different quality and at different prices, the airlines try to segment the market into consumers with higher and lower WTP. First class, business, premium economy, and economy cabins, as well as tickets that come with expedited security services, priority boarding, and lounge access, are all examples of the product differentiation. Furthermore, fare classes and fare basis codes are the most important yield management innovation introduced by the airlines. Fare basis codes are used for selling less desirable flights cheaper, such as those flying mid-week or off-season, in combination with booking classes, as well as imposing fare rule penalties on refunds and/or exchanges, thus constituting product differentiation. On the other hand, two prime examples of price discrimination, also often achieved using fare basis codes, are providing a corporate discounts and (separately) imposing an advanced purchase restriction. Thus, corporate customers often get a price break on the same product thanks to volume sales a corporation achieves. Similarly, the same seat being sold far in advance is typically cheaper than that sold last minute. A typical problem with the latter strategy is that it locks out perspective low-WTP customers who were unable or unwilling to commit to travel in advance while precluding an airline from dropping last-minute prices, so that business customers stepping on a plane in the last minute do not catch the same price break and discretionary customers do not develop a habit of buying cheap travel late.

There are other approaches used by airline service providers to sell tickets with offers which yield profits and also optimize the revenue and managing inventory for the airline, thus ensuring to supply consumers with the best products for which they are willing to pay. For example, a prospective purchaser purchasing an airline ticket may commit to purchasing an airline ticket at a reduced price, but the transaction may only occur if the seller makes the ticket available at a designated time near the date of departure. In such scenarios, the utility in a commercial sale of airline tickets is limited. First, the buyer is required to make a commitment in advance without any certainty of getting on a flight.

Second, the buyer is effectively precluded from booking a hotel at his chosen destination because of the uncertainty that the trip will occur, and booking a last-minute hotel may offset any savings from the discounted airfare. Third, on routes with frequent last-minute seat availability, many buyers are likely to adjust their behavior and postpone the full price purchase in favor of an acquisition uncertainty ticket. This creates more empty seats and perpetuates a vicious cycle. Thus, the consumer is not sure whether the ticket will be booked or not till near the date of departure.

Another approach of revenue management by airlines is, for example, a Name-Your-Own-Price® (NYOP®) distribution platform that sells opaque fares through buyer-driven pricing. In this NYOP platform (also referred to as the “Priceline® system”), a customer makes a conditional purchase offer by specifying some characteristics of the itinerary (such as origin, destination, and dates) and the price he/she is willing to pay. The request is a commitment by the customer to buy at the offered price. Once the request is made, the Priceline® system searches for an airline that is willing to sell a flight ticket below that price and sends an accept/reject decision back to the customer within a specific time period. If the airline accepts the offer (i.e., a fare exists at or below the buyer-requested price), the flight is booked and the customer is charged. Priceline® keeps the margin between the customer-quoted price and the airline price.

Hotwire® offers a platform where, instead of buyer-driven pricing, the price is disclosed upfront, while the details of the itinerary remain opaque until after the purchase. The opaque sales channels are inferior, both from the airline perspective and from the customer perspective. The opaqueness of the fare downgrades the product by making it less valuable in an attempt to discourage consumption by the high-WTP customers. NYOP® customers must accept considerable uncertainty over the details of their itinerary, including not knowing the airline they will fly, the number of connections, or the exact times of arrival and departure.

In Priceline® system's implementation, customers are also required to guess the price of an airline ticket and, in an attempt to discourage repeat bidding, wait for a period of time before making another offer. Thus, a buyer may be required to spend a considerable amount of time only to end up with a suboptimal product. In addition, many high-WTP customers exhibit low-WTP behavior. While some business and leisure travelers are likely to be discouraged by the deliberate uncertainty introduced into the transaction (in terms of arrival time, routing, and number of stops), others will perceive the opaque fare as a perfect substitute for the non-opaque fare that allows the buyer to travel from origin to destination and return on the specified dates, resulting in the cannibalization of high-WTP fares, including business fares.

Prepaid airline tickets are made available for purchase in advance of the flights so that the buyer may convert to a specific flight itinerary shortly before the departure, within certain specified parameters (such as a range of dates, a type of seat, etc.), and subject to seat availability. Unlike the unspecified-time ticket, the buyer is not forced to accept whatever flight and seat the airline offers, and has more flexibility to choose within a range of seats available at the very last minute. For both seller- and buyer-driven prepaid tickets, the buyer does not have the certainty of ticket availability until the last minute. Also, the itinerary is either opaque (some but not all of its attributes are known) or, if not opaque, may present the buyer with a limited selection of last-minute unsatisfactory choices. Hence, there remains a need for market segmentation and consequent price differentiation while balancing the interests of the airline and/or travel website, where customers are likely to pay close to their individual WTP, as well as those of a customer, who is least inconvenienced by the price discrimination mechanism.

### SUMMARY

The disclosed embodiments provide a system that facilitates a purchase of a travel product. Upon receiving a commitment to purchase the travel product from a first supplier by a buyer, the system presents the buyer with a first upgrade option of a first premium travel product from a second supplier. If the buyer accepts the first upgrade option, the system processes the purchase with the first premium travel product. If the buyer declines the first upgrade option, the system processes the purchase with the travel product.

In some embodiments, the system also selects the first upgrade option based on one or more attributes associated with the travel product.

In some embodiments, the one or more attributes include at least one of:

(i) a price associated with the commitment to purchase;

(ii) a location of the travel product;

(iii) a quality of the travel product;

(iv) a brand of the travel product;

(v) a type of the travel product;

(vi) an amenity of the travel product;

(vii) an availability of the first upgrade option; and

(viii) a preference of the buyer.

In some embodiments, the system also presents the buyer with a second upgrade option of a second premium travel product. If the buyer accepts the second upgrade option, the system processes the purchase with the second upgrade option.

In some embodiments, the system also indicates an eligibility of the travel product for the first upgrade option to the buyer prior to receiving the commitment to purchase the travel product from the buyer.

In some embodiments, the commitment to purchase is associated with a penalty if the buyer does not go through with the purchase of the travel product.

In some embodiments, the first premium travel product is associated with at least one of:

(i) a higher price than the travel product;

(ii) a higher rating than the travel product;

(iii) better reviews than the travel product; and

(iv) better amenities than the travel product.

In some embodiments, the first upgrade option is associated with at least one of:

(i) a complimentary upgrade to the first premium travel product;

(ii) a fee for upgrading to the first premium travel product;

(iii) additional information from the buyer;

(iv) a referral from the buyer;

(v) promotion of the first premium travel product by the buyer; and

(vi) the buyer committing to engaging in a promotional activity associated with the first premium travel product (e.g., a social network post).

In some embodiments, the travel product is a flight, a hotel, a rental car, a cruise, a tour, and/or a travel package.

In some embodiments, the upgraded travel product is not easily exchangeable or transferable. (Otherwise, a buyer can obtain the upgraded travel product and sell it on the open market to an unsegmented customer). For example, this can be accomplished by making a hotel reservation non-refundable, non-transferable.

In some embodiments, the upgraded travel product may be “guaranteed” to have some characteristics (not merely to exist). For example, if an upgraded hotel room can be guaranteed to be in a new hotel that is located within two miles of an originally purchased hotel room, and the new hotel can be guaranteed to have a rating with one more star than the original hotel.

In some embodiments, if an upgrade option is unavailable (e.g., the availability of the upgrade option changed), the system can allow the buyer to cancel the original travel product without a fee, or alternatively, can give the buyer a value-added product instead, such as a suite upgrade, a dinner coupon, a gift card, etc.

In some embodiments, the buyer's eligibility for an upgrade option and the selection of an upgrade option for the buyer can be partially determined based on information obtained from the buyer's profile information.

In some embodiments, if the travel product is a hotel room, the provider of the upgrade option can require that the upgrade option only be offered to buyer's who have made a commitment to purchase a hotel room from a pre-specified “white list” of hotels.

In some embodiments, an upgrade option is partially opaque, which means that some of the details of the upgrade option are hidden, until the upgrade option is accepted.

In some embodiments, the system may complete the original booking and then offer the upgrade option. If a user accepts the option, the system may cancel the original booking and book the upgrade product.

In some embodiments, the system may place the original booking on hold while offering the upgrade option. If a user accepts the option, the system may remove the hold or let it expire on its own and book the upgrade product.

### BRIEF DESCRIPTION OF THE FIGURES

FIG. 1A illustrates a price demand curve used for price differentiation in airlines in accordance with the disclosed embodiments.

FIG. 1B illustrates a graphical representation of a typical differential pricing technique of a product in accordance with the disclosed embodiments.

FIG. 2 shows a schematic of a system in accordance with the disclosed embodiments.

FIG. 3A shows an exemplary screenshot in accordance with the disclosed embodiments.

FIG. 3B shows an exemplary screenshot in accordance with the disclosed embodiments.

FIG. 4 shows a flowchart illustrating the process of facilitating a purchase of a travel product in accordance with the disclosed embodiments.

FIG. 5 shows a computer system in accordance with the disclosed embodiments.

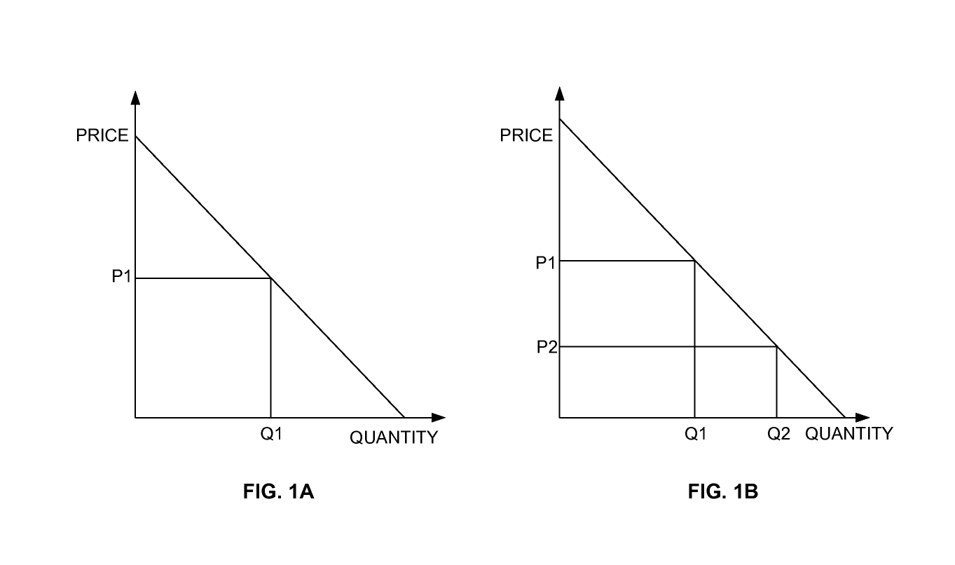

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

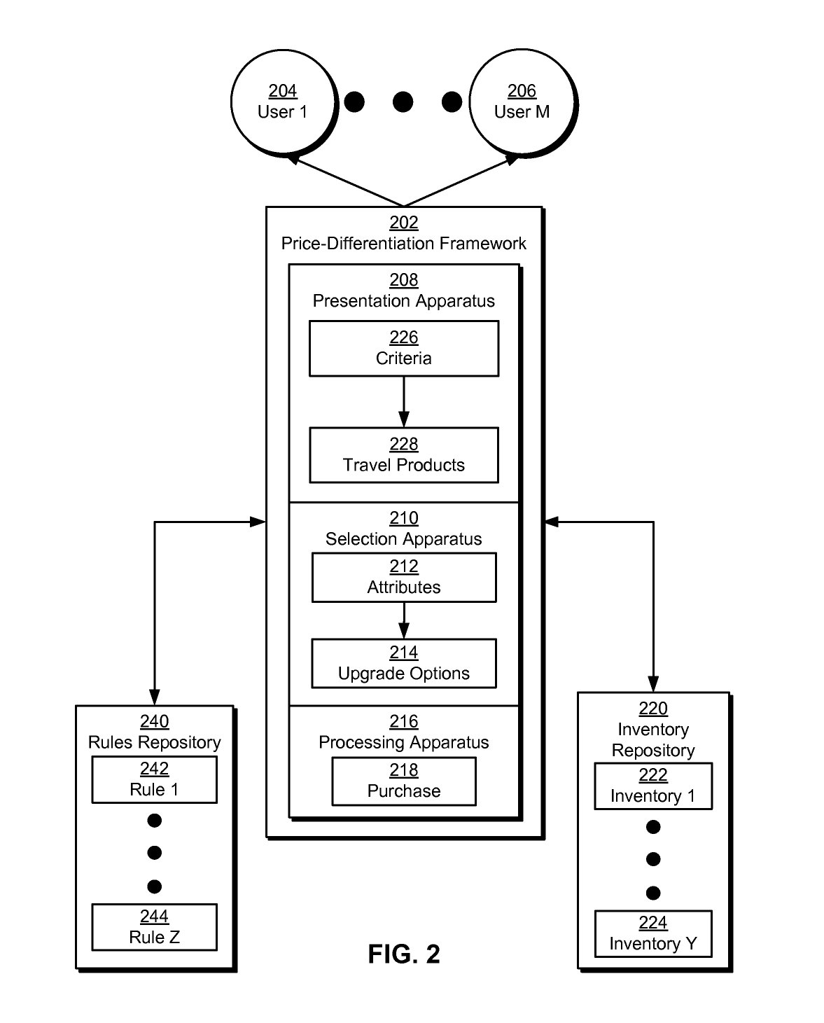

The disclosed embodiments provide a method and system for facilitating the purchase of travel products such as flights, hotels, rental cars, cruises, tours, and/or travel packages. As shown in FIG. 2, the system may correspond to a price-differentiation framework 202 that is accessed by a set of users (e.g., user 1 204, user M 206). (Note that these users are also referred to as “buyers”) Price-differentiation framework 202 includes a presentation apparatus 208, a selection apparatus 210, and a processing apparatus 216. Each of the components of price-differentiation framework 202 is described below.

In one or more embodiments, price-differentiation framework 202 allows the users to find and purchase travel products 228. For example, price-differentiation framework 202 may provide a website for browsing, searching, and/or booking flights, hotels, rental cars, cruises, tours, and/or travel packages. Price-differentiation framework 202 may also be accessed through a natively installed application on an electronic device such as a mobile phone, tablet computer, portable media player, laptop computer, and/or personal computer, in lieu of or in addition to the web-based user interface provided by the website.

During use of price-differentiation framework 202, a user may specify a set of criteria 226 associated with booking travel products 228. For example, the user may specify travel dates, locations, price ranges, star ratings, user ratings, names, reward programs, and/or features or amenities associated with one or more types of travel products 228 to be purchased through price-differentiation framework 202. Presentation apparatus 208 may match available inventory (e.g., inventory 1 222, inventory Y 224) of travel products 228 from an inventory repository 220 to criteria 226 and provide the matching travel products 228 to the user. For example, presentation apparatus 208 may use one or more application-programming interfaces (APIs) to query one or more providers of travel products (e.g., airlines, hotels, rental car companies, cruise companies, tour companies, etc.) and/or databases for travel products 228 matching criteria 226. Presentation apparatus 208 may then list the matching travel products within a website, mobile application, and/or other mechanism for interacting with the user.

The user may then select a travel product within presentation apparatus 208 for booking, and processing apparatus 216 may process a purchase 218 of the travel product by the user. For example, presentation apparatus 208 and/or processing apparatus 216 may confirm the details of purchase 218 (e.g., dates, locations, prices, amenities, etc.) with the user, obtain payment (e.g., credit card, debit card, electronic check, online payment) information from the user, collect traveler information (e.g. names, security information, etc.) and perform purchase 218 by booking the travel product using the payment information.

In one or more embodiments, price-differentiation framework 202 uses upgrade options 214 associated with travel products (e.g., travel products 228) to provide price differentiation of the travel products. Each upgrade option may represent a premium version of a travel product shown to the user. For example, the upgrade option may be associated with a premium travel product with a higher price, a higher rating, better reviews, and/or better amenities than the travel product. Thus, a three-star hotel may be an upgrade option for a two-star hotel, while a four-star hotel may be an upgrade option for both the three-star hotel and the two-star hotel.

In addition, upgrade options for a given travel product may be offered by suppliers other than the supplier of the travel product. For example, an upgrade option for an airline ticket may include an itinerary on a different airline with fewer stops, a better class of service, greater flexibility, and/or shorter travel time. An upgrade option for a hotel room may be provided by a different hotel with a higher star rating, user rating, better location, and/or better amenities. An upgrade option for a rental car may be offered by a different car rental company and include a larger and/or more luxurious car, free gas, and/or a free loss damage waiver. An upgrade option on a cruise may be offered by a different cruise company and include a better and/or more expensive room, increased dining options, free drinks, and/or onboard credit.

As shown in FIG. 2, selection apparatus 210 may select upgrade options 214 based on attributes 212 associated with travel products 228 and/or a set of rules (e.g., rule 1 242, rule z 244) from a rules repository 240. Attributes 212 may include prices, locations, qualities, brands, types, and/or amenities associated with travel products 228. Attributes 212 may also include an availability of upgrade options 214 and/or the user's preferences.

Rules from rules repository 240 may describe the applicability of premium travel products as upgrade options 214 based on attributes 212 of travel products 228. For example, rules for offering a premium travel product as an upgrade option for a travel product may specify a minimum price to be paid for the premium travel product; the number of premium travel products available as upgrade options; and/or the name brands, qualities (e.g., star ratings), and/or types of travel products eligible for upgrade to a given premium travel product. The rules may be provided by suppliers of the premium travel products (e.g., hotels, car rental companies, cruise companies, tour companies, airlines, etc.) as well as the service provider and aggregated in rules repository 240 for use by price-differentiation framework 202.

If a travel product is associated with one or more upgrade options, presentation apparatus 208 may indicate the eligibility of the travel product for the upgrade option(s). For example, presentation apparatus 208 may display a symbol, an icon, and/or text within and/or next to a description of the travel product as the user browses a list of travel products 228 matching criteria 226. As a result, the user may be notified of the opportunity to upgrade the travel product to one or more premium travel products without receiving information about the premium travel product(s).

Instead, the user may be presented with details of the upgrade option(s) after the user provides a commitment to purchase 218 the travel product. For example, presentation apparatus 208 may receive the user's commitment to purchase 218 the travel product after the user provides payment information and agrees to be charged for the travel product. Presentation apparatus 208 may then provide an upgrade option of a premium travel product from a different supplier to the user. For example, presentation apparatus 208 may include details such as the name, location, star rating, user rating, and/or amenities of the premium travel product.

In addition, the upgrade option may be offered for free to the user, or the upgrade option may be associated with a fee for upgrading to the premium travel product. For example, the upgrade option may include a complimentary upgrade to the premium travel product if the price of the travel product meets the minimum price for purchasing the premium travel product, as specified by rules in rules repository 240. Conversely, if the price of the travel product is too low to qualify for a complimentary upgrade, the upgrade option may be available for the price difference between the price of the travel product and the minimum price for purchasing the premium travel product.

The user may also be required to meet one or more other conditions to qualify for the upgrade to the premium travel product. For example, the user may be required to provide additional information that can be used for market research purposes, refer one or more other users to price-differentiation framework 202, and/or promote price-differentiation framework 202 and/or purchase 218 of the premium travel product on a social network.

The user may then complete purchase 218 with either the original travel product or the premium travel product offered in the upgrade option. If the user accepts the upgrade option, processing apparatus 216 may process purchase 218 with the premium travel product. The system may complete the original booking before offering the upgrade option and cancel this booking when the upgrade option is accepted. Alternatively, a system may place the original booking on hold while offering the upgrade option. If a user accepts the option, the system may remove the hold or let it expire on its own. If the user declines the upgrade option, processing apparatus 216 may process purchase 218 with the original travel product. Finally, the user may be required to pay a penalty if the user does not go through with purchase 218 of either the travel product or the premium travel product. For example, the user may be required to forfeit the price of purchase 218 and/or pay a different amount if the user backs out of purchase 218.

If multiple upgrade options are associated with the travel product, the user may be presented with some or all of the upgrade options. For example, selection apparatus 210 may select a subset of the upgrade options for presentation to the user based on the amount of premium travel product inventory associated with each upgrade option, the similarity between certain attributes of the premium travel products and the travel product (e.g., room type, flight itinerary, tour destinations, cruise itinerary, trip length, etc.), the conditions of the upgrade options (e.g., fees, additional information, referrals, promotions, etc.), the difference in “quality” (e.g., star rating, user reviews, car class, cabin class, etc.) between the travel product and the premium travel products, and/or the user's preferences and/or past behavior. Alternatively, presentation apparatus 208 may list all available upgrade options, and the user may select an upgrade option from the list or proceed with purchase 218 of the original travel product. Some of the upgrade conditions may be different among the upgrade options, such as being associated with different additional fees.

Consequently, the system of FIG. 2 may present a hurdle that constitutes a commitment to purchase 218 a travel product and presentation of details of an upgrade option to a premium travel product after the commitment is made. Because the user has committed to purchasing the original travel product without knowing the details of the premium travel product, which may be unacceptable to the user, the hurdle may segment the market into users who are willing to purchase original, non-upgraded travel products and users who are not willing to make such purchases. Such segmentation may allow suppliers of premium travel products to offer lower price points to users in the first category, thus enticing the users to purchase the premium travel products and facilitating the sale of excess premium inventory while continuing to sell to users in the second category at the normal, higher price point. In addition, the use of rules to match upgrade options to travel products may allow suppliers and/or sellers of the premium travel products to apply optimization strategies that target specific types of users and/or aggregate demand by offering a single premium travel product as an upgrade for multiple travel products (e.g., hotels with a certain star rating).

Those skilled in the art will appreciate that the system of FIG. 2 may be implemented in a variety of ways. First, presentation apparatus 208, selection apparatus 210, processing apparatus 216, rules repository 240, and inventory repository 220 may be provided by a single physical machine, multiple computer systems, one or more virtual machines, a grid, one or more databases, one or more filesystems, and/or a cloud computing system. In addition, presentation apparatus 208, selection apparatus 210, and/or processing apparatus 216 may be implemented together or separately by one or more hardware and/or software components and/or layers.

Second, as mentioned above, inventory and rules associated with travel products and premium travel products may be obtained and/or aggregated from a number of sources. For example, price-differentiation framework 202 may communicate with one or more booking systems, travel suppliers, and/or extranets to obtain travel inventory and/or rules for inclusion in inventory repository 220 and/or rules repository 240, respectively.

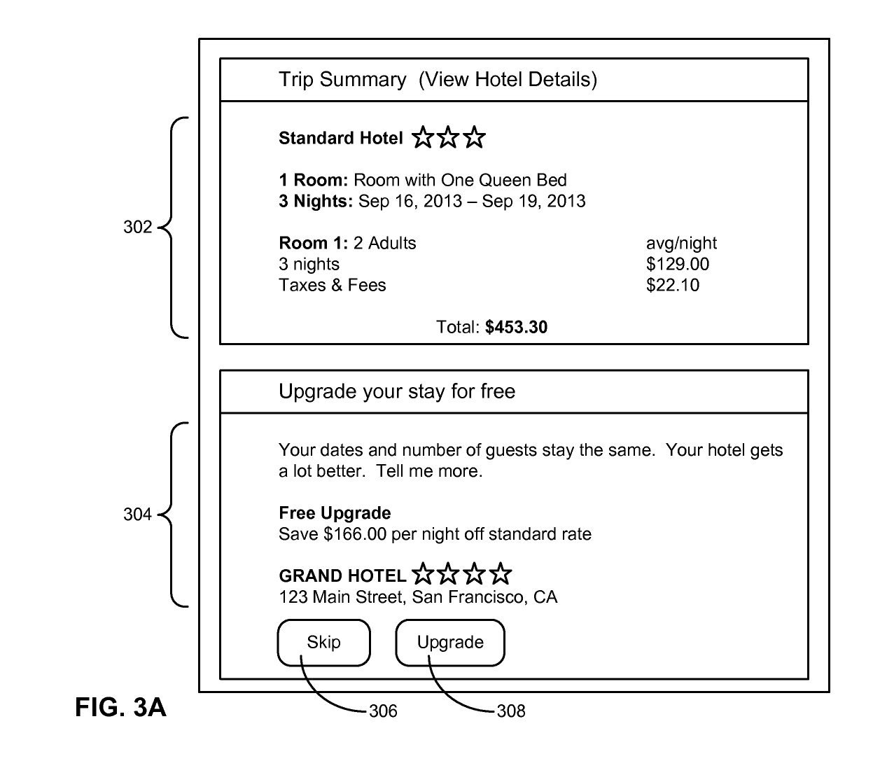

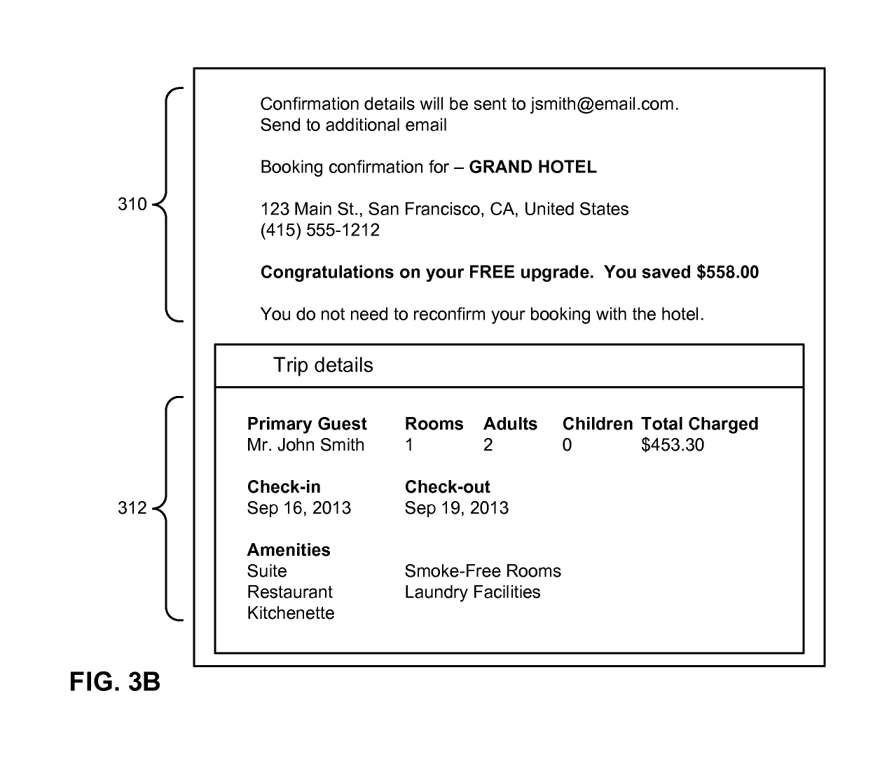

FIG. 3A shows an exemplary screenshot in accordance with the disclosed embodiments. More specifically, FIG. 3A shows a screenshot of a user interface provided by a presentation apparatus, such as presentation apparatus 208 of FIG. 2. As shown in FIG. 3A, the user interface includes information 302 associated with a user's commitment to purchase a travel product such as a hotel room. For example, information 302 may include the name (e.g., “Standard Hotel”) of the travel product, the type (e.g., “1 Room: Room with One Queen Bed”) of the travel product, booking details (e.g., “3 Nights: Sep. 16, 2013-Sep. 19, 2013,” “Room 1: 2 Adults,” “3 nights”) for the travel product, and pricing information (e.g., “Total: $453.30”) for the travel product. Information 302 may be shown to the user before the user has provided payment information and agreed to the terms of the commitment to purchase the travel product and then confirmed upon purchase.

The user interface of FIG. 3A also includes information 304 associated with an upgrade option of a premium travel product. First, information 304 may notify the user of the upgrade option (e.g., “Your dates and number of guests stay the same. Your hotel gets a lot better.”). Next, information 304 may include information about the savings associated with the upgrade option (e.g., “Save $166.00 per night off standard rate”), as well as details about the premium travel product (e.g., “GRAND HOTEL,” “123 Main Street, San Francisco, Calif.”). The user interface may also include links within information 304 to allow the user to access more details of the upgrade option and/or premium travel product. This information reveals the upgrade option and is shown in its entirety upon receiving a purchase commitment from the user.

Finally, the user interface of FIG. 3A includes a set of buttons 306-308. The user may select button 306 (e.g., “Skip”) to decline the upgrade option. On the other hand, the user may select button 308 (e.g., “Upgrade”) to accept the upgrade option.

FIG. 3B shows an exemplary screenshot in accordance with the disclosed embodiments. In particular, FIG. 3B shows a screenshot of the user interface of FIG. 3A after the user has selected button 308, thereby accepting the upgrade option. As shown in FIG. 3B, the user interface includes information 310 related to the confirmed purchase of the premium travel product. For example, information 310 may include the name (e.g., “GRAND HOTEL”), location (e.g., “123 Main St., San Francisco, Calif., United States”), and phone number (e.g., “(415) 555-1212”) of the premium travel product. Information 310 may also include details about the amount saved (e.g., “Congratulations on your FREE upgrade. You saved $498.00”) by the user in selecting the upgrade option.

The user interface may also include details 312 associated with the purchase. For example, details 312 may specify the name of a guest (e.g., “Mr. John Smith”) using the premium travel product; the number of rooms (e.g., “1”), adults (e.g., “2”), and children (e.g., “0”) associated with use of the premium travel product; the amount paid (e.g., “$453.30”) for the premium travel product; and check-in (e.g., “Sep. 16, 2013”) and check-out (e.g., “Sep. 19, 2013”) dates for the premium travel product. Finally, details 312 may include a set of amenities (e.g., “Suite,” “Smoke-Free Rooms,” “Restaurant,” “Laundry Facilities,” “Kitchenette”) of the premium travel product.

By providing an upgrade option for the travel product, the user interface may allow a supplier of the premium travel product to sell the premium travel product at a price that is acceptable to the user. At the same time, the occlusion of details of the premium travel product until after the user has committed to purchasing the travel product may segment the user from other users who are not willing to purchase the travel product and would rather pay a higher price for a guaranteed booking of the premium travel product.

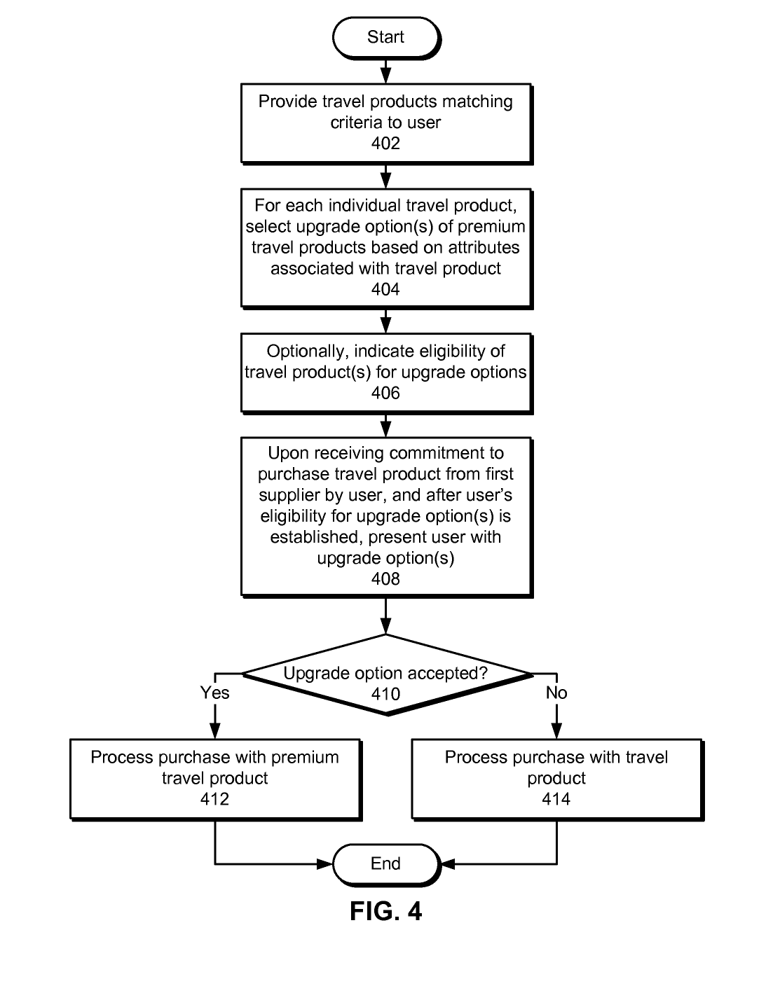

FIG. 4 shows a flowchart illustrating the process of facilitating a purchase of a travel product in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of travel products matching a set of criteria is provided to a user (operation 402). The criteria may be provided by the user while browsing and/or searching for travel products to book and/or purchase. For example, the user may specify dates, locations, price ranges, names or name brands, reward or loyalty programs, star ratings, user ratings, types of travel products, and/or other criteria for filtering the travel products. Available travel products (e.g., flights, hotels, rental cars, cruises, tours, travel packages, etc.) that match the criteria may then be shown to the user within a website, mobile application, and/or other mechanism for interacting with the user.

Next, individually for each travel product, one or more upgrade options of premium travel products are selected based on attributes associated with the travel product and those of the user profile (operation 404). The premium travel products may be associated with higher prices, higher ratings, better reviews, and/or better amenities than the corresponding travel products. The attributes may include a price associated with the commitment to purchase, a location of the travel product, a quality of the travel product, a brand of the travel product, a type of the travel product, an amenity of the travel product, an availability of the upgrade options, and/or a preference of the user. A set of rules may be applied to the attributes for each travel product to determine if any upgrade options exist for the travel product.

The eligibility of one or more travel products for upgrade options is then optionally indicated (operation 406) to the user. For example, an icon, symbol, and/or text indicating the availability of one or more upgrade options may be shown next to and/or within a description of each eligible travel product. In addition, certain details of the premium travel product could be disclosed. For example, if a travel product is a 3-star hotel, a user can be informed that he/she would be offered a 4-star hotel as an upgrade option.

Upon receiving a commitment to purchase a travel product from a first supplier by the user, and after the user's eligibility for upgrade option(s) is established, the user is presented with the upgrade option(s) for the travel product (operation 408). For example, the commitment to purchase may be received from the user as payment information and an agreement to be charged for the travel product using the payment information. Upgrade options of premium travel products from other suppliers may then be shown to the user to allow the user to select an upgrade option in lieu of the travel product. In addition, each upgrade option may be associated with a complimentary upgrade to the corresponding premium travel product, or the upgrade option may be subject to one or more conditions. For example, the upgrade option may include a fee for upgrading to the premium travel product, request additional information from the user, require a referral from the user, and/or require promotion of the premium travel product by the user.

The purchase may then be processed based on the user's acceptance of an upgrade option (operation 410). If the user accepts the upgrade option, the purchase is processed with the premium travel product (operation 412). If the user declines the upgrade option, the purchase is processed with the original travel product (operation 414). Finally, if the user does not go through with the commitment to purchase either the travel product or the premium travel product, the user may pay a penalty, such as a cancellation fee.

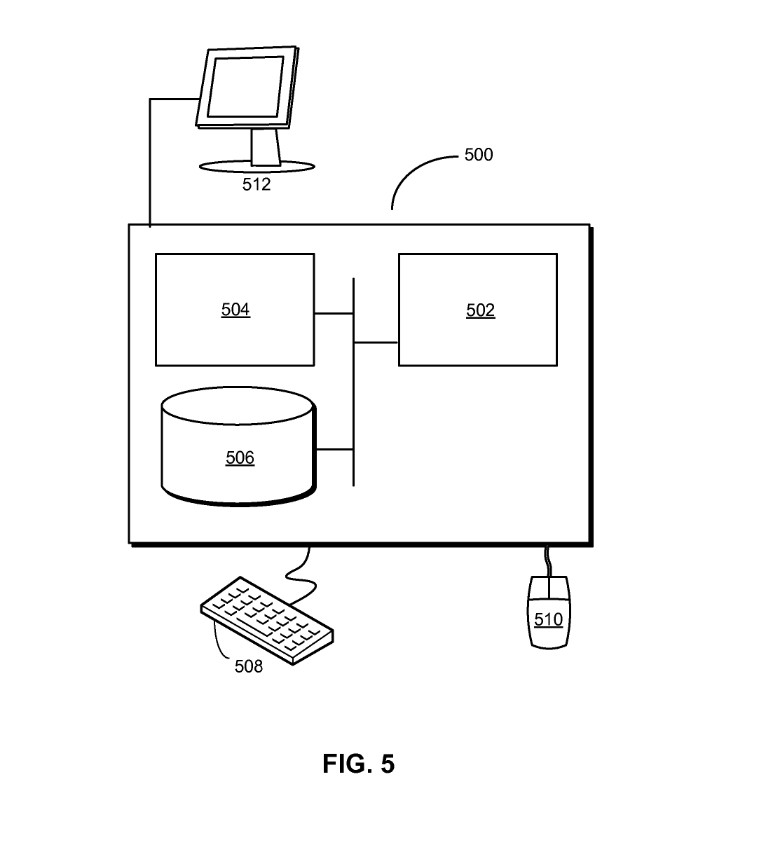

FIG. 5 shows a computer system 500 in accordance with an embodiment. Computer system 500 may correspond to an apparatus that includes a processor 502, memory 504, storage 506, and/or other components found in electronic computing devices such as personal computers, laptop computers, workstations, servers, mobile phones, tablet computers, and/or portable media players. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for facilitating a purchase of a travel product. The system may include a presentation apparatus. Upon receiving a commitment to purchase the travel product from a first supplier by a user, the presentation apparatus may present the user with a first upgrade option of a first premium travel product from a second supplier. The system may also include a selection apparatus that selects the first upgrade option based on one or more attributes associated with the travel product. Finally, the system may include a processing apparatus that processes the purchase with the first premium travel product if the buyer accepts the first upgrade option. On the other hand, if the buyer declines the first upgrade option, the processing apparatus may process the purchase with the travel product.

In addition, one or more components of computer system 500 may be remotely located and connected to the other components over a network. Portions of the present embodiments (e.g., presentation apparatus, selection apparatus, processing apparatus, etc.) may also be located on different nodes of a distributed system that implements the embodiments. For example, the present embodiments may be implemented using a cloud computing system that uses upgrade options to provide price differentiation of travel products to a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating a purchase of a travel product, comprising:
upon receiving a commitment to purchase the travel product from a first supplier by a buyer, presenting the buyer with a first upgrade option of a first premium travel product from a second supplier;
if the buyer accepts the first upgrade option, processing the purchase with the first premium travel product; and
if the buyer declines the first upgrade option, processing the purchase with the travel product.

2. The computer-implemented of claim 1, wherein if the buyer accepts an upgrade option, processing the purchase involves charging an additional fee for the upgrade option.

3. The computer-implemented method of claim 1, further comprising:
selecting the first upgrade option based on one or more attributes associated with the travel product.

4. The computer-implemented method of claim 3, wherein the one or more attributes comprise at least one of:
a price associated with the commitment to purchase;
a location of the travel product;
a quality of the travel product;
a brand of the travel product;
a type of the travel product;
an amenity of the travel product;
an availability of the first upgrade option; and
a preference of the buyer.

5. The computer-implemented method of claim 1,
wherein presenting the buyer with the first upgrade option involves presenting the buyer with several upgrade options associated with several premium travel products;
if the buyer accepts any of the presented upgrade options, processing the purchase with the accepted upgrade option.

6. The computer-implemented method of claim 1, further comprising:
indicating an eligibility of the travel product for the first upgrade option to the buyer prior to receiving the commitment to purchase the travel product from the buyer.

7. The computer-implemented method of claim 1, wherein the commitment to purchase is associated with a penalty if the buyer does not go through with the purchase of the travel product.

8. The computer-implemented method of claim 1, wherein the first premium travel product is associated with at least one of:
a higher price than the travel product;
a higher rating than the travel product;
better reviews than the travel product; and
better amenities than the travel product.

9. The computer-implemented method of claim 1, wherein the travel product is at least one of:
a flight;
a hotel;
a rental car;
a cruise;
a tour; and
a travel package.

10. A system for facilitating a purchase of a travel product, comprising:
a presentation apparatus, wherein upon receiving a commitment to purchase the travel product from a first supplier by a buyer, the presentation apparatus is configured to present the buyer with a first upgrade option of a first premium travel product from a second supplier; and
a processing apparatus configured to:
if the buyer accepts the first upgrade option, process the purchase with the first premium travel product; and
if the buyer declines the first upgrade option, process the purchase with the travel product.

11. The system of claim 10, wherein if the buyer accepts an upgrade option, the processing apparatus is configured to charge an additional fee for the upgrade option.

12. The system of claim 10, further comprising:
a selection apparatus configured to select the first upgrade option based on one or more attributes associated with the travel product.

13. The system of claim 10,
wherein while presenting the buyer with the first upgrade option, the presentation apparatus is configured to present the buyer with several upgrade options associated with several premium travel products; and
wherein if the buyer accepts any of the presented upgrade options, the processing apparatus is further configured to process the purchase with the accepted upgrade option.

14. The system of claim 10, wherein the presentation apparatus is further configured to:
indicate an eligibility of the travel product for the first upgrade option to the buyer prior to receiving the commitment to purchase the travel product from the buyer.

15. The system of claim 10, wherein the first upgrade option is associated with at least one of:
a complimentary upgrade to the first premium travel product;
a fee for upgrading to the first premium travel product;
additional information from the buyer;
a referral from the buyer; and
promotion of the first premium travel product by the buyer.

16. The system of claim 10, wherein the travel product is at least one of:
a flight;
a hotel;
a rental car;
a cruise;
a tour; and
a travel package.

17. A computer-readable storage medium storing instructions that when executed by a computer cause the computer to perform a method for facilitating a purchase of a travel product, the method comprising:
upon receiving a commitment to purchase the travel product from a first supplier by a buyer, presenting the buyer with a first upgrade option of a first premium travel product from a second supplier;
if the buyer accepts the first upgrade option, processing the purchase with the first premium travel product; and
if the buyer declines the first upgrade option, processing the purchase with the travel product.

18. The computer-readable storage medium of claim 17, wherein if the buyer accepts an upgrade option, processing the purchase involves charging an additional fee for the upgrade option.

19. The computer-readable storage medium of claim 17, the method further comprising:
selecting the first upgrade option based on one or more attributes associated with the travel product.

20. The computer-readable storage medium of claim 19, wherein the one or more attributes comprise at least one of:
a price associated with the commitment to purchase;
a location of the travel product;
a quality of the travel product;
a brand of the travel product;
a type of the travel product;
an amenity of the travel product;
an availability of the first upgrade option; and
a preference of the buyer.

21. The computer-readable storage medium of claim 17, the method further comprising:
presenting the buyer with a second upgrade option of a second premium travel product; and
if the buyer accepts the second upgrade option, processing the purchase with the second upgrade option.

22. The computer-readable storage medium of claim 17, the method further comprising:
indicating an eligibility of the travel product for the first upgrade option to the buyer prior to receiving the commitment to purchase the travel product from the buyer.

23. The computer-readable storage medium of claim 17, wherein the first upgrade option is associated with at least one of:
a complimentary upgrade to the first premium travel product;
a fee for upgrading to the first premium travel product;
additional information from the buyer;
a referral from the buyer; and
promotion of the first premium travel product by the buyer.
